(19) United States
(12) Patent Application Publication
(10) Pub. No.: US 2013/0271513 A1
(43) Pub. Date: Oct. 17, 2013

(54) DISPLAY DEVICE INCLUDING BACKLIGHT UNIT

(71) Applicant: SAMSUNG DISPLAY CO., LTD., Yongin-City (KR)

(72) Inventors: Sang-Heon PARK, Asan-si (KR); Seungjae KANG, Asan-si (KR); Namsoo KANG, Asan-si (KR); WooIl PARK, Yongin-si (KR)

(73) Assignee: Samsung Display Co., Ltd., Yongin-City (KR)

(21) Appl. No.: 13/733,824

(22) Filed: Jan. 3, 2013

(30) Foreign Application Priority Data
Apr. 12, 2012 (KR) 10-2012-0038084

(51) Int. Cl. G09G 3/34

(52) U.S. Cl. CPC G09G 3/3406
USPC 345/691; 345/690

(57) ABSTRACT

A display device includes a display panel with a plurality of pixels connected to a plurality of gate lines and a plurality of data lines, a data driver driving the plurality of data lines, a gate driver driving the plurality of gate lines, a backlight unit which includes a plurality of Light Emitting Diodes (LEDs) supplying light to the display panel, and a control unit. The backlight unit outputs a rank signal corresponding to a rank of the LEDs, where the rank of the LEDs corresponds to a color coordinate of light emitted from the LEDs. The control unit controls the data driver, the gate driver, and the backlight unit in response to a first image signal and a control signal, converts the first image signal into a second image signal in response to the rank signal, and provides the second image signal to the data driver.

### CROSS-REFERENCE TO RELATED APPLICATIONS

This application claims priority to Korean Patent Application No. 10-2012-0038084, filed on Apr. 12, 2012, and all the benefits accruing therefrom under 35 U.S.C. §119, the content of which in its entirety is herein incorporated by reference.

### BACKGROUND OF THE INVENTION

Embodiments of the present invention relate generally to a display device, and more particularly, to a display device including a backlight unit.

A liquid crystal display (LCD), i.e., currently one of the most common display devices, is a light-receiving device that displays an image by adjusting or modulating the amount of light entering from an external source. Thus, an additional light source for projecting light upon a liquid crystal panel, i.e., a backlight unit (BLU) including a backlight lamp, is employed.

Recent efforts have focused on making such backlight units compact, thin, and lightweight. Accordingly, some backlight units have employed one or more light emitting diodes (LEDs), which are advantageous for power consumption, weight, and brightness.

The backlight unit includes an LED array in which a plurality of LEDs is sequentially connected. The LED array is classified based on its brightness and color coordinates. The brightness is generally in units of luminous intensity or luminous flux, and the color coordinates are generally CIE1931 (xy coordinates) or CIE1976 (u′v′ coordinates).

In general, the LCD includes an LED array classified with the same brightness and same coordinates. Therefore, according to the brightness and color coordinate specifications that the LCD has, an area of the LED array used is restricted.

### SUMMARY OF THE INVENTION

The present invention provides a display device in which various types of LEDs can be used in the same backlight.

Embodiments of the invention provide a display device including: a plurality of gate lines, a plurality of data lines which cross the plurality of gate lines, a display panel which comprises a plurality of pixels connected to the plurality of the gate lines and the plurality of the data lines, a data driver configured to drive the plurality of data lines, a gate driver configured to drive the plurality of gate lines, a backlight unit which includes a plurality of light emitting diodes (LEDs) configured to supply light to the display panel, and which is configured to output a rank signal corresponding to a rank of the plurality of LEDs, the rank of the plurality of LEDs corresponding to a color coordinate of light emitted from the plurality of LEDs; and a control unitconfigured to convert the first image signal into a second image signal in response to the rank signal, and configured to provide the second image signal to the data driver.

In exemplary embodiments, the control unit may include a timing controller configured to output first through third control signals for control of the data driver, the gate driver, and the backlight unit respectively, wherein the timing controller is further configured to output the first through third control signals in response to the first image signal, the control signal, and a rank detection signal. The control unit may also include a backlight driving unit configured to control the backlight unit in response to the third control signal from the timing controller, and to output a rank detection signal corresponding to the rank signal. The timing controller is further configured to convert the first image signal into the second image signal according to a compensation value corresponding to the rank detection signal.

In exemplary embodiments, the backlight unit may further include a rank circuit configured to output the rank signal when a power voltage is supplied to the backlight unit.

In exemplary embodiments, the rank circuit may include a resistor connected between a power node configured to receive a power voltage, and at least one output node for output of the rank signal.

In exemplary embodiments, the backlight driving unit may be configured to detect a current level of the rank signal output from the at least one output node of the rank circuit, and may be configured to output a level of the rank detection signal corresponding to the detected current level.

In exemplary embodiments, a resistance value of the resistor connected between the power node and the at least one output node may correspond to a rank of the plurality of LEDs.

In exemplary embodiments, the rank circuit may include a power node configured to supply the power voltage, K output nodes (where K is a positive integer) each configured to output the rank signal, and J resistors (where J is a positive integer and J≦K) each respectively connected to the power node and one of the K output nodes.

In exemplary embodiments, the backlight driving unit may include K pull-down resistors, each having one end connected to a corresponding output node among the K output nodes, and another end connected to a ground, wherein the rank detection signal comprises outputs of one end of each of the K pull-down resistors.

In exemplary embodiments, the timing controller may further include a memory storing a plurality of compensation values that respectively correspond to a plurality of the ranks, wherein the timing controller is configured to read the compensation value corresponding to the rank detection signal from the memory, and to convert the first image signal into the second image signal according to the read compensation value.

In exemplary embodiments, the backlight unit may include a flexible printed circuit (FPC) on which the plurality of LEDs and the rank circuit are mounted.

In a further exemplary embodiment, a display device includes a plurality of data lines which cross a plurality of gate lines, and a display panel which comprises a plurality of pixels connected to the plurality of the gate lines and the plurality of the data lines. The device also includes a data driver configured to drive the plurality of data lines, a gate driver configured to drive the plurality of gate lines, and a timing controller configured to control the data driver and the gate driver in response to a received first image signal and a control signal. The device further includes a backlight unit which includes a plurality of LEDs configured to supply light to the display panel. The backlight unit is further configured to output a rank signal corresponding to a rank of the plurality of LEDs, where the rank of the plurality of LEDs corresponds to a color coordinate of light emitted from the plurality of LEDs. The device also includes a backlight driving unit configured to control the backlight unit and to output a rank detection signal corresponding to the rank signal. The timing controller is further configured to control the backlight driving unit and to convert the first image signal into a second image signal according to a compensation value corresponding to the rank detection signal.

In exemplary embodiments, the backlight unit may include a resistor connected between a power node configured to receive a power voltage, and at least one output node configured to output the rank signal.

In exemplary embodiments, the backlight driving unit may be configured to detect the rank signal, and to output a level of the rank detection signal corresponding to the detected rank signal.

In exemplary embodiments, the timing controller may further include a memory storing a plurality of compensation values that respectively correspond to a plurality of the ranks, and the timing controller may be further configured to read the compensation value corresponding to the rank detection signal from the memory, and to convert the first image signal into the second image signal according to the read compensation value.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a circuit configuration of a liquid crystal display device according to an embodiment;

FIG. 2 is an exploded perspective view of a liquid crystal display device of FIG. 1;

FIG. 3 is a view illustrating various color coordinate distributions of a white LED according to quality distribution;

FIG. 4 is a specific view illustrating a backlight unit and a backlight driving unit of FIG. 1;

FIG. 5 is a conceptual view illustrating a configuration of a memory of FIG. 1; and

FIG. 6 is a view illustrating a backlight unit and a backlight driving unit of FIG. 1 according to another embodiment.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, an exemplary embodiment of the present invention is described in conjunction with the accompanying drawings.

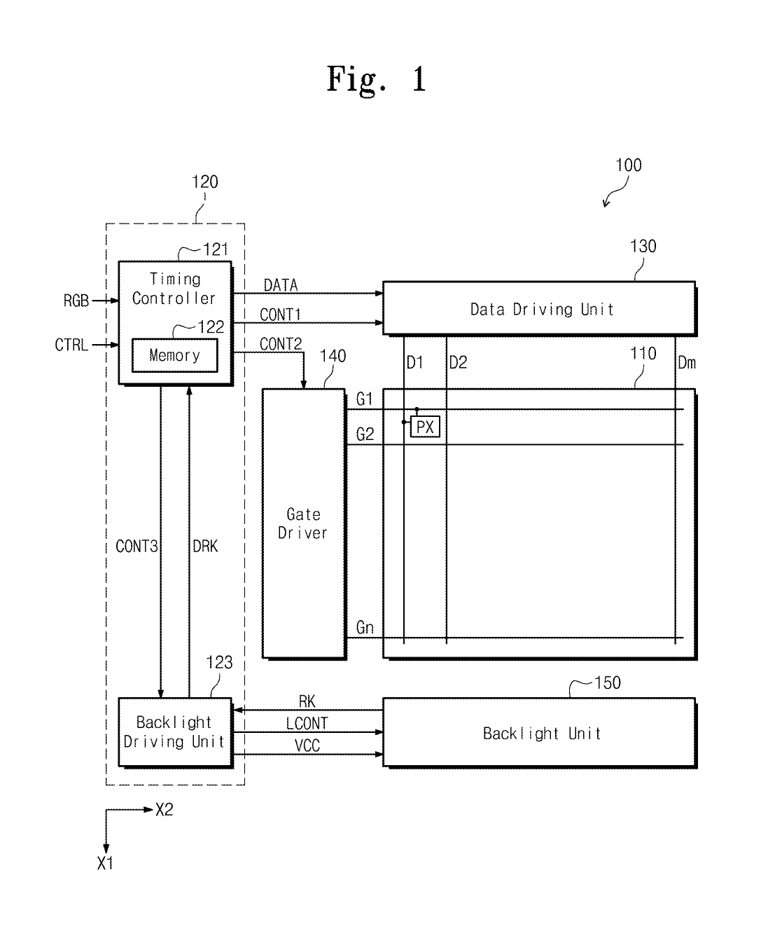

FIG. 1 is a view illustrating a circuit configuration of a liquid crystal display device according to an embodiment. In the description below, the liquid crystal display device is shown and described as one example of a display device. However, the present invention is not limited to liquid crystal display devices, and can be applied to any display device that employs a backlight unit.

Referring to FIG. 1, the liquid crystal display device 100 includes a liquid crystal panel 110, a control unit 120, a data driver 130, a gate driver 140, and a backlight unit 150. The control unit 120 includes a timing controller 121 and a backlight driving unit 123.

The liquid crystal panel 110 includes a plurality of data lines D1 to Dm extending generally in a first direction X1, a plurality of gate lines G1 to Gn intersecting the data lines D1 to Dm and extending generally in a second direction X2, and a plurality of sub pixels Px arranged in a matrix at the intersection areas of the lines G1 to Gn and D1 to Dm.

Although each sub pixel Px is not shown in the drawing, each includes a switching transistor connected to a corresponding data line and gate line, as well as a liquid crystal capacitor and a storage capacitor connected thereto.

The timing controller 121 receives a first image signal RGB and control signals CTRL for controlling the display of the first image signal RGB. The signals RGB and CTRL are received from an external source. The control signals CTRL include a vertical sync signal Vsync, a horizontal sync signal Hsync, a main clock signal MCLK, and a data enable signal DE. The timing controller 121 provides a second image signal DATA which is processed according to operational conditions of the liquid crystal panel 110 on the basis of the control signals CTRL, and a first control signal CONT1 to the data driver 130. The timing controller 121 also provides a second control signal CONT2 to the gate driver 140. The first control signal CONT1 includes a horizontal sync start signal STH, a clock signal HCLK, and a line latch signal TP. The second control signal CONT2 includes a vertical sync start signal STR1 and an output enable signal OE. The timing controller 121 outputs a third control signal CONT3 for controlling the backlight unit 150 to the backlight driving unit 123.

The data driver 130 outputs gradation voltages to drive each of the data lines D1 to Dm according to the second image signal DATA and the first control signal CONT1.

The gate driver 140 drives the gate lines G1 to Gn in response to the second control signal CONT2. The gate driver 140 includes a gate driving integrated circuit (IC). Alternatively, instead of the gate driving IC, the gate driver 140 may be implemented with an amorphous silicon gate (ASG) circuit using an amorphous silicon thin film transistor a-Si TFT.

While a gate on voltage VON is applied to one gate line, the switching transistors connected thereto in one row are turned on. During this time, the data driver 130 provides gradation voltages corresponding to the data signal DATA to the data lines D1 to Dm. The gradation voltages applied to the data lines D1 to Dm are applied to corresponding sub pixels through the turned-on switching transistors.

The backlight unit 150 is disposed at the rear of the liquid crystal panel 110, thereby providing light to the liquid crystal panel 110. The backlight driving unit 123 outputs a backlight control signal LCONT for controlling the backlight unit 150 in response to the third control signal CONT3. The backlight control signal LCONT is a signal for adjusting the brightness, in addition to turning on/off an operation, of the backlight unit 150.

Here, the backlight unit 150 includes a plurality of LEDs and outputs a rank signal RK corresponding to a rank of the plurality of LEDs. The backlight driving unit 123 detects the rank signal RK and provides a rank detection signal DRK corresponding to the detected rank signal RK to the timing controller 121.

The timing controller 121 includes a memory 122. The memory 122 stores gradation compensation values corresponding to a plurality of the abovementioned ranks. The timing controller 121 reads from the memory 122 the gradation compensation value corresponding to the rank indicated by the rank detection signal DRK from the backlight driving unit 123. The timing controller 121 then converts the first image signal RGB into the second image signal DATA by using the gradation compensation value read from the memory 121.

Current LED manufacturing techniques still have difficulties in the mass-production of LEDs having brightness and emission wavelength characteristics consistently within a desirable allowable range.

The timing controller 120 of the present invention compensates the first image signal RGB with a compensation value corresponding to a rank of the LEDs in the backlight unit 150, in order to output the second image signal DATA. Therefore, the backlight unit 150 may be able to use various rank types of LEDs.

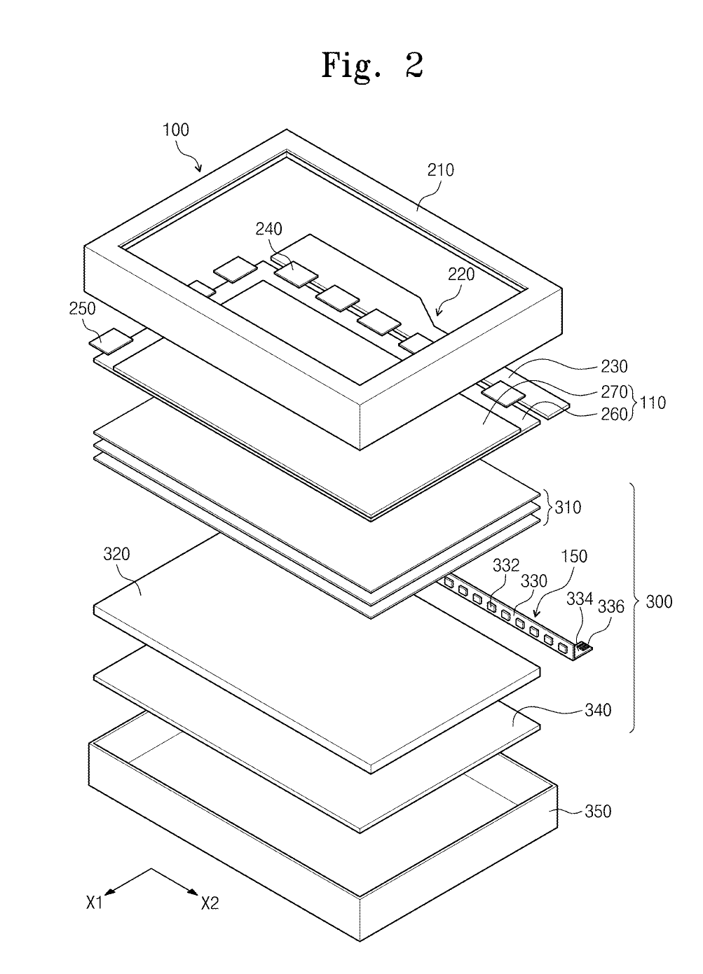

FIG. 2 is an exploded perspective view of the liquid crystal display device of FIG. 1.

Referring to FIG. 2, the liquid crystal display device 100 includes a liquid crystal panel assembly 220, a backlight assembly 300, an upper receiving container 210, and a bottom receiving container 350. Additionally, an integrated printed circuit board 230 may include several components for processing a gate control signal CONT2 input to a gate tape carrier package 250 and a data control signal CONT1 input to a data tape carrier package 240. That is, the integrated printed circuit board 230 may access the liquid crystal panel 110 in order to provide image information.

The backlight assembly 300 includes optical sheets 310, a light guide plate 320, a backlight unit 150, and a reflective sheet 340. The light guide plate 320 guides the light supplied from the backlight unit 150 to the liquid crystal panel 110. The light guide plate 320 may be a plate made of a plastic-based transparent material. For example, the light guide plate 320 may be made of acrylic resin such as PolyMethyl MethAcrylate (PMMA) or polycarbonate. When light incident to one side of the light guide plate 320 reaches the top or bottom of the light guide plate 320 at more than a critical angle of the light guide plate 320, it is substantially completely reflected from the surface of the light guide plate 320 without being emitted out of the light guide plate 320, and thus, is uniformly delivered to the entire inside of the light guide plate 320.

Moreover, a diffusion pattern (not shown) may be formed on at least one of the top and bottom of the light guide plate 320 in order to allow the light in the light guide plate 320 to be emitted to the liquid crystal panel 110 seated on the top of the light guide plate 320. A diffusion pattern may also be formed at the bottom of the light guide plate 320. That is, a light traveling through the inside of the light guide plate 320 may be reflected by the diffusion pattern and emitted through the top of the light guide plate 320.

The backlight unit 150 is disposed at one side of the light guide plate 320. In order to uniformly deliver light on an entire display screen in such an arrangement structure, the light guide plate 320 may be formed as a substantially flat platelike structure having a substantially uniform thickness. However, the present invention is not limited thereto. That is, various shapes of light guide plates are applicable. The backlight unit 150 is disposed at one side of the light guide plate 320, and includes a plurality of light emitting blocks providing light.

The reflective sheet 340 is installed at the bottom of the light guide plate 320 in order to reflect light emitted from the bottom of the light guide plate 320 back into the light guide plate 320 (and eventually toward the panel 110). That is, the reflective sheet 340 reflects light back toward the outgoing side of the light guide plate 320, thereby reducing loss of light incident to the liquid crystal panel 110, and also improving the uniformity of the light penetrating the outgoing side of the light guide plate 320.

The optical sheets 310 are installed at the top surface of the light guide plate 320 to serve to diffuse and/or collect the light delivered from the light guide plate 320. The optical sheets 310 include a diffusion sheet, a prism sheet, and a protective sheet. The diffusion sheet is between the light guide plate 320 and the prism sheet, and diffuses the light incident from the light guide plate 320, thereby preventing the light from being overly concentrated in any one location. The prism sheet is formed when prisms, generally of triangular (or any other) shaped cross section, are uniformly arranged on the top surface, and typically includes two sheets. Each prism arrangement is disposed to be staggered at a predetermined angle, so that the prism sheet serves to collect the light diffused from the diffusion sheet in a direction normal to the liquid crystal panel 110. Therefore, almost all the light penetrating the prism sheet proceeds in a vertical direction, so that brightness on the protective sheet may be more uniform. The protective sheet formed on the prism sheet serves to protect the surface of the prism sheet and also serves to further diffuse the light in order for more uniform light distribution. A configuration of the optical sheets 310 is not limited to the above, and thus, varies according to the standard of the liquid crystal device 100.

The liquid crystal panel 110 is installed on the protective sheet, and is seated together with the backlight assembly 300 into the bottom receiving container 350. The bottom receiving container 350 has sidewalls formed along the edge of its floor in order to receive and fix the backlight assembly 300 and the liquid crystal panel assembly 220, and also to prevent the back light assembly 300 from being bent. Additionally, the integrated printed circuit board 230 of the liquid crystal panel assembly 220 is cut along the outer surface of the bottom receiving container 350 and is seated on the bottom of the bottom receiving container 350. Here, according to a method of receiving the backlight assembly 300 or the liquid crystal panel assembly 220 in the bottom receiving container 350, the shape of the bottom receiving container 350 may vary. Furthermore, the top receiving container 210 may be coupled to the bottom receiving container 350 in order to cover the top of the liquid crystal panel assembly 220 when the assembly 220 is seated in the bottom receiving container 350. A window may be formed on the top surface of the top receiving container 210 in order to expose the liquid crystal panel assembly 220.

The backlight unit 150 includes a plurality of LEDs 332. The plurality of LEDs is fixed side by side (i.e., arranged in a line) on a flexible printed circuit 330. A wiring part 334 electrically connects a connection terminal 336 with the plurality of LEDs 332. The connection terminal 336 is connected to the backlight driving unit 123 of FIG. 1. Therefore, a power voltage VCC from the backlight driving part 123 is supplied to the plurality of LEDs 332 through the connection terminal 336 and the wiring part 334.

As one example, each of the plurality of LEDs 332 is a white LED. The white LED may emit white light by combining a blue LED and a yellow phosphor, and may have various color coordinates obtained by adjusting a combination ratio of the blue LED and the yellow phosphor. The white LED may control white color according to a combination ratio of the blue LED and the yellow phosphor, but due to variations in quality, white LEDs of varying color coordinate areas are often produced.

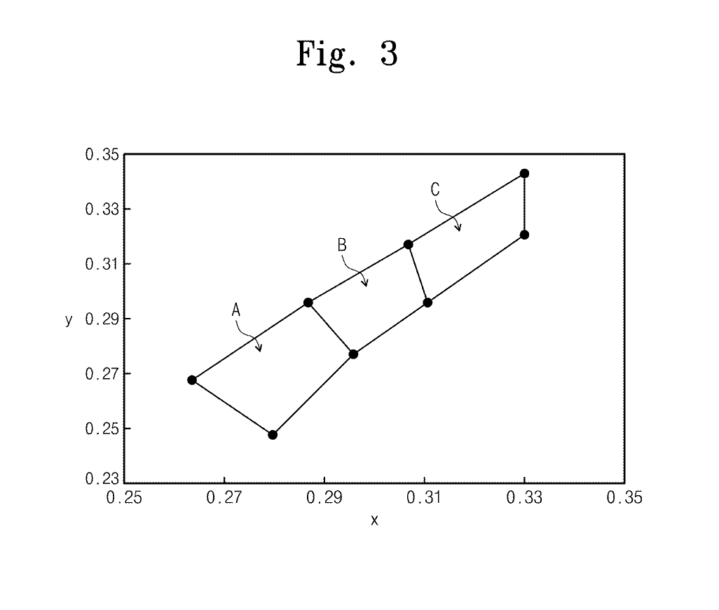

FIG. 3 is a view illustrating various color coordinate distributions of white LEDs and their corresponding quality ranks.

Referring to FIG. 3, a representative color coordinate distribution of white LEDs is divided into three different areas (hereinafter, referred to as “ranks”) according to a combination ratio of a blue LED and a yellow phosphor. That is, the color coordinate distribution is divided into an A-rank, a B-rank, and a C-rank according to color coordinate. The three ranks are classified according to a color temperature of the LED. In general, if an LED appropriate for a liquid crystal display device is of the A-rank, the B-rank and the C-rank cannot currently be applied to the liquid crystal display. In contrast, the liquid crystal display device 100 according to an embodiment of the present invention is configured with, and operates in order to use, white LEDs of the B-rank and the C-rank in addition to the A-rank.

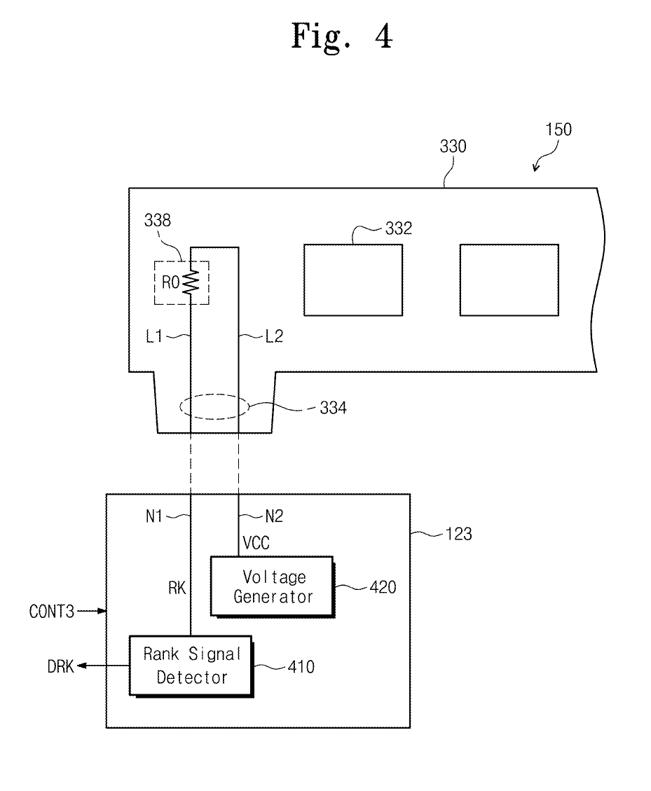

FIG. 4 is a view illustrating the backlight unit and the backlight driving unit of FIG. 1.

Referring to FIG. 4, the backlight unit 150 includes LEDs 332 and a rank circuit 338, which are arranged on the flexible printed circuit 330. The resistor R0 of the rank circuit 338 is connected between an output node L1 and a power node L2 to which a power voltage VCC is supplied. The resistor R0 has a resistance value corresponding to a rank of the LEDs 332. The wiring part 334 may further include wires and other circuitry used in operations of the LEDs 332 in addition to operations of the output node L1 and the power node L2.

The backlight driving unit 123 may control the on/off and brightness of the LEDs 332 equipped in the backlight unit 150 in response to the third control signal CONT3. Additionally, the backlight driving unit 123 includes a rank signal detector 410 and a voltage generator 420. A detection node N1 of the rank signal detector 410 is connected to output node L1 of the backlight unit 150. The rank signal detector 410 detects a current level received from the detection node N1 in order to output a rank detection signal DRK. The voltage generator 420 generates a power voltage VCC, and outputs it through a power supply node N2. The power supply node N2 of the voltage generator 420 is electrically connected to the power node L2 of the backlight unit 150.

When the backlight unit 150 and the backlight driving unit 123 are coupled and a power supply VCC is supplied from the voltage generator 420 to the power node N2, a current flowing through the resistor R0 is input to the rank signal detector 410 as a rank signal RK.

The rank signal detector 410 outputs the rank detection signal DRK, corresponding to a current level of the rank signal RK, to the timing controller 121 of FIG. 1. For example, if the LEDs 332 are A-rank LEDs, the resistance value of the resistor R0 is set to a first value. If the LEDs 332 are B-rank LEDs, the resistance value of the resistor R0 is set to a second value. If the LEDs 332 are C-rank LEDs, the resistance value of the resistor R0 is set to a third value. The resistance of the resistor R0 can be set during the initial construction of the backlight unit 150, such as by selecting the appropriate-resistance resistor corresponding to the LEDs 332 that are installed. That is, once a particular set of LEDs 332 having a particular rank or ranks are installed, the corresponding resistor can be selected and installed.

Since a current level of the rank signal RK is changed according to the resistance value of the resistor R0, the rank signal detector 410 outputs the rank detection signal DRK corresponding to the rank of the LEDs 332.

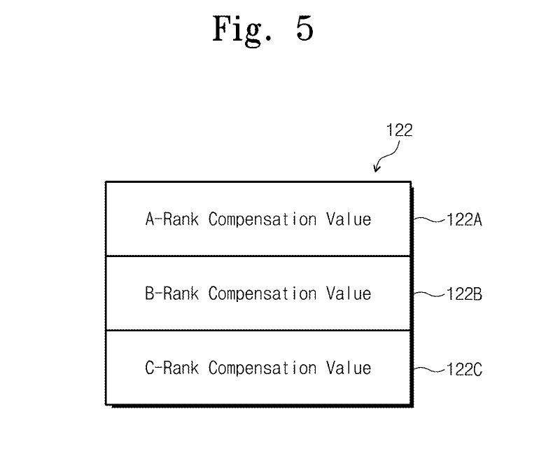

FIG. 5 is a conceptual view illustrating a configuration of the memory of FIG. 1.

Referring to FIG. 5, the memory 122 includes a first region 122A, a second region 122B, and a third region 122C. If an LED in the backlight unit 150 is an A-rank LED, the first region 122A of the memory 122 stores a compensation value corresponding thereto. If an LED in the backlight unit 150 is a B-rank LED, the second region 122B of the memory 122 stores a compensation value corresponding thereto. If an LED in the backlight unit 150 is a C-rank LED, the third region 122C of the memory 122 stores a compensation value corresponding thereto.

When the rank detection signal from the backlight driving unit 123 corresponds to an A-rank, the timing controller 121 of FIG. 1 reads a compensation value stored in the first region 122A of the memory 122. When the rank detection signal from the backlight driving unit 123 corresponds to a B-rank, the timing controller 121 reads a compensation value stored in the second region 122B of the memory 122. When the rank detection signal from the backlight driving unit 123 corresponds to a C-rank, the timing controller 121 reads a compensation value stored in the third region 122C of the memory 122. The timing controller 121 compensates the first image signal RGB with the compensation value read from the memory 122 in order to output the second image signal DATA.

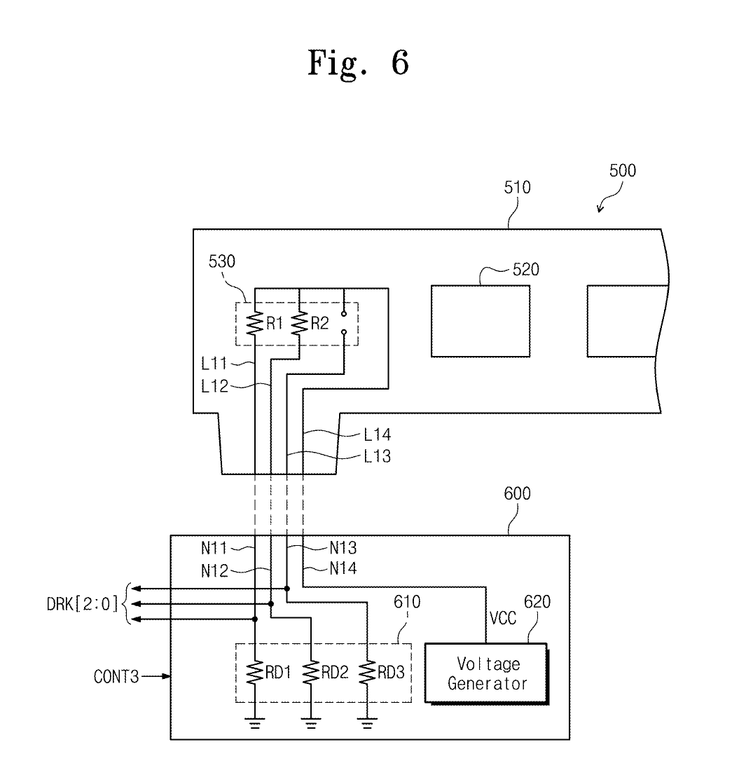

FIG. 6 is a view illustrating a configuration of a backlight unit and a backlight driving unit according to another embodiment of the present invention.

Referring to FIG. 6, unlike the rank circuit 338 in the backlight unit 150 of FIG. 4 which includes one resistor R0, a rank circuit 530 of the backlight unit 500 can include up to three resistors R1, R2, and R3 (not shown). Here, the rank circuit 530 includes two resistors R1 and R2, but not R3 (although as below, R3 can be connected between the rightmost terminals of circuit 530 if desired). The rank is determined by the number of resistors R1, R2, R3 installed, as will be further explained below. One end of each of the two resistors R1 and R2 is connected to a power node L14, and the other ends are connected to first and second output nodes L11 and L12, respectively. In this embodiment, a third output node L13 is not connected to a resistor.

The backlight driving unit 600 includes a rank signal detector 610 and a voltage generator 620. The rank signal detector 610 includes first, second, and third pull-down resistors RD1, RD2, and RD3. One end of each of the first, second, and third pull-down resistors RD1, RD2, and RD3 is connected to a ground voltage, and other ends are connected to first through third detection nodes N11, N12, and N13, respectively. The voltage generator 620 generates a power voltage VCC and outputs it to the power supply node N14. The power supply node N14 of the voltage generator 620 is electrically connected to the power node L14 of the backlight unit 500.

When the backlight unit 500 and the backlight driving unit 600 are connected and a power voltage VCC is supplied from the voltage generator 620 to the power node N14, a current flowing through the resistors R1 and R2 is input to the rank signal detector 610.

Since the rank signal detector 610 includes the first to third pull-down resistors RD1, RD2, and RD3, it can be seen that each of the first to third detection nodes N11, N12, and N13 may have a high or low level voltage according to whether a resistor is connected to the corresponding first to third nodes L11, L12, and L13 of the backlight unit 500.

In this embodiment, the resistors R1 and R2 are respectively connected to the first and second output nodes L11 and L12 of the backlight unit 150, respectively, and a resistor is not connected to the third output node N13. Therefore, each of the rank detection signals DRK[2] and DRK[1] of the first node N11 and the second node N12 in the backlight driving unit 600 is at a high level, and the rank detection signal DRK[0] of the third node N13 is set at a low level.

For example, if the LEDs 520 are A-rank LEDs, the resistor R1 is connected between the power node L14 and the first output node L11. If the LEDs 520 are B-rank LEDs, the resistors R1 and R2 are connected between the power node L14 and the first and second output nodes L11 and L12. If the LEDs 520 are C-rank LEDs, the resistors R1, R2, and R3 are connected between the power node L14 and the first to third output nodes L11, L12, and L13.

The number of resistors R1, R2, and R3 that are connected determines the number of bits, or the level, of the rank detection signal DRK[2:0]. Accordingly, the rank detection signal DRK[2:0] indicates the rank of the LEDs 520.

In the embodiment of FIG. 6, the rank signal detector 610 detects a maximum of three LED ranks, corresponding to resistors R1, R2, and R3. However, the number of LED ranks that a liquid crystal display device detects may vary. That is, the rank circuit 530 can include any number of resistors Rn, connected between power node L14 and its own line Lx, so that rank detection signal DRK[2:0] can take on any desired number of levels.

Moreover, the rank signal detector 610 may be configured in the timing controller 121 instead of the backlight driving unit 123. In this case, the first to third output nodes L11, L12, and L13 of the backlight unit 500 may be electrically connected to the timing controller 121.

According to the present invention, when a backlight unit is coupled with a display panel, the display panel can detect the brightness and color coordinate specifications of an LED in the backlight unit. Additionally, the display panel performs data signal conversion appropriate for the detected brightness and color coordinate specifications. Therefore, a display device may use various types of LEDs as a backlight without reduction in display quality. Thus, manufacturing costs may be reduced and display quality improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A display device comprising:
a plurality of gate lines;
a plurality of data lines which cross the plurality of gate lines;
a display panel which comprises a plurality of pixels connected to the plurality of the gate lines and the plurality of the data lines;
a data driver configured to drive the plurality of data lines;
a gate driver configured to drive the plurality of gate lines;
a backlight unit which comprises a plurality of light emitting diodes (LEDs) configured to supply light to the display panel, and which is configured to output a rank signal corresponding to a rank of the plurality of LEDs, the rank of the plurality of LEDs corresponding to a color coordinate of light emitted from the plurality of LEDs; and
a control unit configured to convert a first image signal into a second image signal in response to the rank signal, and configured to provide the second image signal to the data driver.

2. The display device of claim 1, wherein the control unit comprises:
a timing controller configured to output first through third control signals for control of the data driver, the gate driver, and the backlight unit respectively, wherein the timing controller is further configured to output the first through third control signals in response to the first image signal, the control signal, and a rank detection signal; and
a backlight driving unit configured to control the backlight unit in response to the third control signal from the timing controller, and to output a rank detection signal corresponding to the rank signal,
wherein the timing controller is further configured to convert the first image signal into the second image signal according to a compensation value corresponding to the rank detection signal.

3. The display device of claim 2, wherein the backlight unit further comprises a rank circuit configured to output the rank signal when a power voltage is supplied to the backlight unit.

4. The display device of claim 3, wherein the rank circuit comprises a resistor connected between a power node configured to receive a power voltage, and at least one output node for output of the rank signal.

5. The display device of claim 4, wherein the backlight driving unit is configured to detect a current level of the rank signal output from the at least one output node of the rank circuit, and is configured to output a level of the rank detection signal corresponding to the detected current level.

6. The display device of claim 4, wherein a resistance value of the resistor connected between the power node and the at least one output node corresponds to the rank of the plurality of LEDs.

7. The display device of claim 3, wherein the rank circuit comprises:
a power node configured to supply the power voltage;
K output nodes (where K is a positive integer) each configured to output the rank signal; and
J resistors (where J is a positive integer and J≦K) each respectively connected to the power node and one of the K output nodes.

8. The display device of claim 7, wherein the backlight driving unit comprises K pull-down resistors, each having one end connected to a corresponding output node among the K output nodes, and another end connected to a ground, wherein the rank detection signal comprises outputs of one end of each of the K pull-down resistors.

9. The display device of claim 2, wherein the timing controller further comprises a memory storing a plurality of compensation values that respectively correspond to a plurality of the ranks,
wherein the timing controller is configured to read the compensation value corresponding to the rank detection signal from the memory, and to convert the first image signal into the second image signal according to the read compensation value.

10. The display device of claim 1, wherein the backlight unit comprises a flexible printed circuit (FPC) on which the plurality of LEDs and the rank circuit are mounted.

11. A display device comprising:
a plurality of gate lines;
a plurality of data lines which cross the plurality of gate lines;
a display panel which comprises a plurality of pixels connected to the plurality of the gate lines and the plurality of the data lines;
a data driver configured to drive the plurality of data lines;
a gate driver configured to drive the plurality of gate lines;
a timing controller configured to control the data driver and the gate driver in response to a received first image signal and a control signal;
a backlight unit which comprises a plurality of LEDs configured to supply light to the display panel, the backlight unit further configured to output a rank signal corresponding to a rank of the plurality of LEDs, the rank of the plurality of LEDs corresponding to a color coordinate of light emitted from the plurality of LEDs; and
a backlight driving unit configured to control the backlight unit and to output a rank detection signal corresponding to the rank signal,
wherein the timing controller is further configured to control the backlight driving unit and to convert the first image signal into a second image signal according to a compensation value corresponding to the rank detection signal.

12. The display device of claim 11, wherein the backlight unit comprises a resistor connected between a power node configured to receive a power voltage, and at least one output node configured to output the rank signal.

13. The display device of claim 12, wherein the backlight driving unit is configured to detect the rank signal, and to output a level of the rank detection signal corresponding to the detected rank signal.

14. The display device of claim 11, wherein the timing controller further comprises a memory which stores a plurality of compensation values that respectively correspond to a plurality of the ranks; and
the timing controller is further configured to read the compensation value corresponding to the rank detection signal from the memory, and to convert the first image signal into the second image signal according to the read compensation value.
